(19) United States
(12) Patent Application Publication
(10) Pub. No.: US 2017/0162083 A1
(43) Pub. Date: Jun. 8, 2017

(54) Directional Sign

(71) Applicant: Harry Stewart Knapp, Woodland Hills, CA (US)

(72) Inventor: Harry Stewart Knapp, Woodland Hills, CA (US)

(21) Appl. No.: 14/960,336

(22) Filed: Dec. 4, 2015

(51) Int. Cl. G09F 7/00

(52) U.S. Cl. CPC G09F 7/00

(57) ABSTRACT

A directional sign has a cuneated shape extending from an otherwise symmetrical shape wherein a corner of the cuneated shape forms a directional-indicating portion of the directional sign. The directional sign may be mounted using mounting apertures formed towards the periphery of the symmetrical shape. The location of the mounting apertures may correspond to the vertexes of an octagon. The pointed orientation of the directional-indicating portion of the directional sign may be changed depending on which one of the mounting apertures is used to mount the directional sign.

### FIELD OF THE INVENTION

The present invention relates to signage.

### BACKGROUND

The following description includes information that may be useful in understanding the present invention. It is not an admission that any of the information provided herein is prior art or relevant to the presently claimed invention, or that any publication specifically or implicitly referenced is prior art.

Signs often have a standard geometric shape such as a rectangle. An arrow often is drawn on the sign to indicate a direction that the reader should go in order to reach a destination. But an arrow may be obscured or difficult to read amid the text printed on the sign. Furthermore, drawing an arrow on the sign reduces the amount of space available for text.

The present invention provides for a novel method and device for providing directional information in a sign.

### SUMMARY OF THE INVENTION

The present invention provides methods and devices for providing directional information in a sign. In one embodiment, the sign comprises board substrate having a symmetrical shape except for a corner portion for indicating a direction. Exact symmetry is not required. In one embodiment, the sign has a circular shape but for the corner which extends away from the circular shape. In an alternative embodiment, the sign has an octagonal shape except for a triangular corner extending from one side of the otherwise octagonal shape.

In one embodiment, the directional sign may be mounted using at least one of a plurality of mounting apertures formed on the generally symmetrical shape. The orientation of the directional-indicating portion of the directional sign may be changed depending on which one of the mounting apertures is used to mount the directional sign. In one embodiment, eight mounting apertures are peripherally located on what would be the vertexes of an octagon.

In another embodiment, the directional sign may be mounted using an octagonal-shaped head to engage an octagonal-shaped mounting aperture in the sign.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a front elevation view of a first embodiment of the directional sign, where the reverse side is identical;

FIG. 2 is a left side elevation view of a first embodiment of the directional sign;

FIG. 3 is a top plan view of a first embodiment of the directional sign;

FIG. 4 is a right side elevation view of a first embodiment of the directional sign;

FIG. 5 is a bottom plan view of a first embodiment of the directional sign;

FIG. 6 is a front elevation view of a second embodiment of the directional sign, where the reverse side is identical;

FIG. 7 is a left side elevation view of a second embodiment of the directional sign;

FIG. 8 is a top plan view of a second embodiment of the directional sign;

FIG. 9 is a right side elevation view of a second embodiment of the directional sign;

FIG. 10 is a bottom plan view of a second embodiment of the directional sign;

FIG. 11 is a front elevation view of a third embodiment of the directional sign, where the reverse side is identical;

FIG. 12 is a left side elevation view a third embodiment of the directional sign;

FIG. 13 is a top plan view of a third embodiment of the directional sign;

FIG. 14 is a right side elevation view of a third embodiment of the directional sign;

FIG. 15 is a bottom plan view of a third embodiment of the directional sign.

FIG. 16 is a front elevation view of a fourth embodiment of the directional sign, where the reverse side is identical;

FIG. 17 is a left side elevation view a fourth embodiment of the directional sign;

FIG. 18 is a top plan view of a fourth embodiment of the directional sign;

FIG. 19 is a right side elevation view of a fourth embodiment of the directional sign;

FIG. 20 is a bottom plan view of a fourth embodiment of the directional sign;

FIG. 21 is a front elevation view of a fifth embodiment of the directional sign, where the reverse side is identical;

FIG. 22 is a left side elevation view of a fifth embodiment of the directional sign;

FIG. 23 is a top plan view of a fifth embodiment of the directional sign;

FIG. 24 is a right side elevation view of a fifth embodiment of the directional sign;

FIG. 25 is a bottom plan view of a fifth embodiment of the directional sign;

FIG. 26 is a front elevation view of a sixth embodiment of the directional sign, where the reverse side is identical;

FIG. 27 is a left side elevation view of a sixth embodiment of the directional sign;

FIG. 28 is a top plan view of a sixth embodiment of the directional sign;

FIG. 29 is a right side elevation view of a sixth embodiment of the directional sign;

FIG. 30 is a bottom plan view of a sixth embodiment of the directional sign.

### DETAILED DESCRIPTION OF EMBODIMENTS

In various embodiments, the directional sign comprises a triangular corner extending from an otherwise uniform geometrical shape. Referring now to the drawings, like parts are designated by like reference characters throughout the several views.

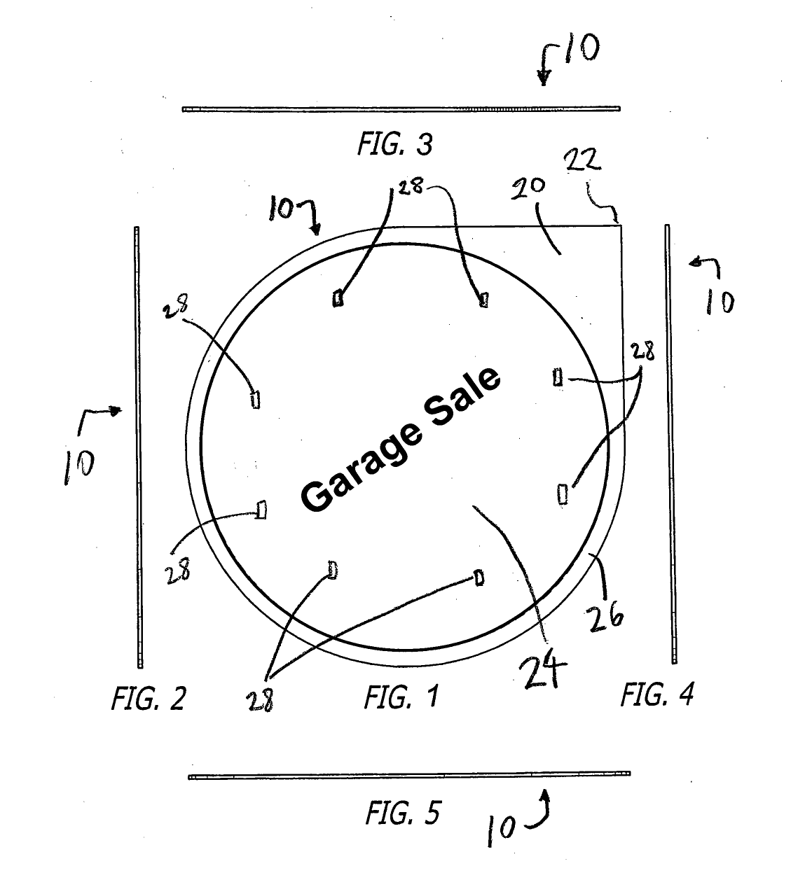

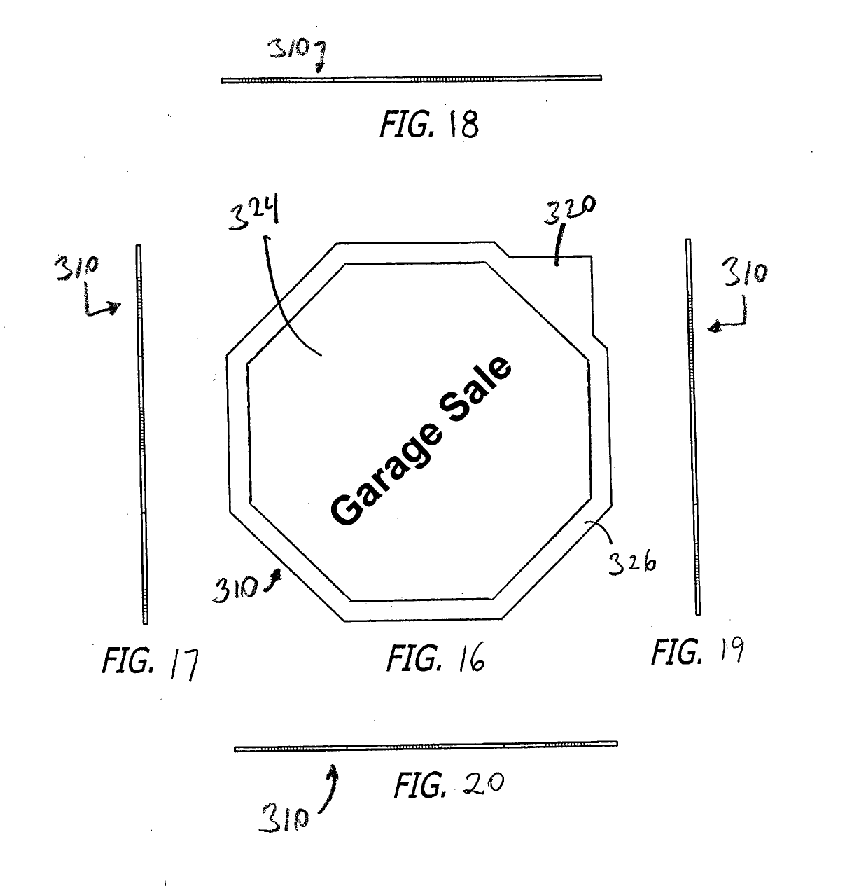

FIGS. 1 through 20 depict various embodiments of the directional sign. The signs illustrated have a shape that is otherwise generally symmetrical but for a triangular or cuneated shape extending from the outer boundary of the otherwise symmetrical shape. The reference to a symmetrical shape does not require that the shape have exact symmetry.

FIGS. 1 through 5 depict a first embodiment of the directional sign 10. The sign 10 preferably has a shape that is otherwise generally symmetrical but for a triangular or cuneated shape extending from the outer boundary of the otherwise generally symmetrical shape. Exact symmetry of the shapes is not required. The shape of the sign 10 preferably is formed using a single substrate such as cardboard, plastic or other suitable signage material. The sign 10 is preferably thin, but may be of any thickness suitable for its intended use. The sign 10 in FIG. 1 is circular, but other shapes may be utilized. The cuneated or corner shape 20 is formed by two straight lines extending as a tangent from the circumference of the circular shape. Although the corner 20 is roughly shown as having a right angle, the corner may have an smaller acute angle or a larger obtuse angle. The corner point 22 can indicate a direction or act as a pointer. In addition to pointing left, right, up, and down, the corner point 22 also can point in other directions and may be placed at a two o'clock, four o'clock, eight o'clock, and ten o'clock position. FIG. 1 shows corner point 22 placed in a two o'clock position. Having the directional-indicating portion as an integral part of the sign's shape, preferably extending from an otherwise generally symmetrical shape, improves the visibility of the directional information of the sign.

Information of a textual or graphical nature may be placed within an interior area 24 inside the circular line, and an border area 26 outside of the circular line may be shaded or colored differently from the interior area 24 which can further increase visibility of the sign.

Preferably, the sign 10 is mounted on a post or other object using at least one of a plurality of mounting apertures 28 formed towards the periphery of the symmetrical shape. As illustrated in FIG. 1, there are eight mounting apertures formed in the substrate of the sign. The location of the eight mounting apertures may correspond to the vertexes of an octagon, preferably an equilateral octagon. The mounting apertures may take the form of slits, preferably located towards the periphery of the sign. Opposing mounting slits for an octagonal pattern may correspond to a seven inch (17.8 cm) diameter for 18-inch (45.7 cm) and 14.5-inch (36.8 cm) signs. The pointing orientation of the point 22 of the corner 20 as the directional-indicating portion of the sign 10 may be changed depending on which one of the mounting apertures is used to mount the directional sign.

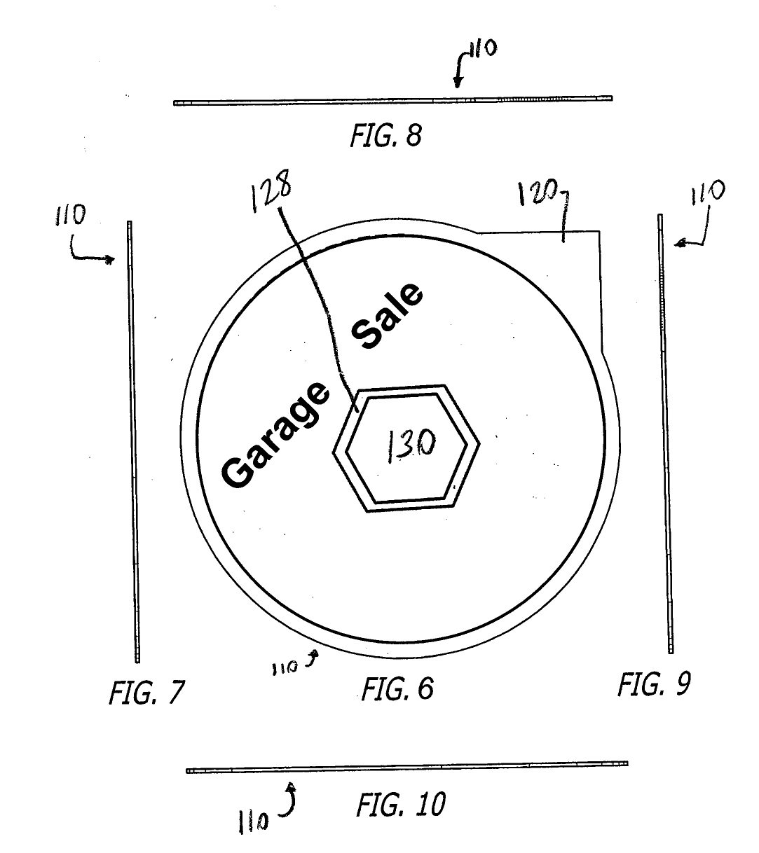

In the alternative, as illustrated in FIG. 6, the sign may be attached to a post or other suitable structure by an octagonal mounting head 130 that engages a corresponding octagonal-shaped aperture 133 formed in the substrate of the sign 110. The orientation of the point of the corner as the directional-indicating portion of the sign may be changed by adjusting the position of octagonal-shaped aperture 128 on the octagonal head. Additional mounting means such as staples or nails may be used to secure the sign to post or other suitable mounting structure.

FIGS. 6 through 10 illustrate a second embodiment similar to that depicted in FIGS. 1 through 5, except that the triangular or cuneated shape 120 extending from the larger shape of the sign 110 is relatively smaller. Textual or graphical information may be placed within the interior area 124, and the border area 126 may be shaded or colored.

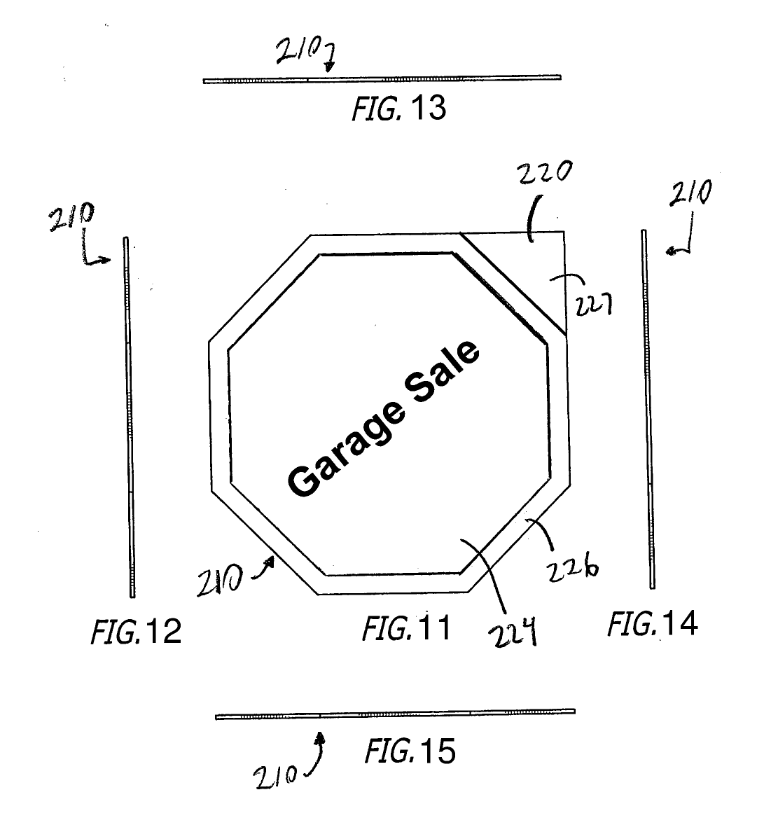

FIGS. 11 through 15 illustrate a third embodiment having a triangular or cuneated shape 220 extending from an octagonal shape for the sign 210. Preferably, as illustrated in FIG. 11, the sign has eight mounting apertures 228 corresponding to the vertexes of an octagon, preferably an equilateral octagon. Opposing mounting apertures for an octagonal pattern may correspond to a seven inch (17.8 cm) diameter for 18-inch (45.7 cm) and 14.5-inch (36.8 cm) signs. Text or graphics may be placed within the area 224 and the peripheral area 226 may be shaded or colored to form a border. The corner or beak portion 227 may have different shading or coloring from the shading or coloring of the border formed by area 226. Alternatively, the corner or beak portion may have the same shading or coloring as the shading or coloring of the border formed by area. The interior of area 224 preferably is not colored or shaded.

FIGS. 16 through 20 illustrate a fourth embodiment similar to that depicted in FIGS. 11 through 15, except that the triangular or cuneated shape 320 extending from the larger shape of the sign 310 is relatively smaller. Preferably, as illustrated in FIG. 16, the sign has eight mounting apertures 328 corresponding to the corners of an octagon, preferably an equilateral octagon. Opposing mounting apertures for an octagonal pattern may correspond to a seven inch (17.8 cm) diameter for 18-inch (45.7 cm) and 14.5-inch (36.8 cm) signs. Text or graphical information may be placed within the interior area 324, and the border area 326 may be colored or shaded. As illustrated in FIG. 16, the mounting apertures 328 may be located within the border area 326.

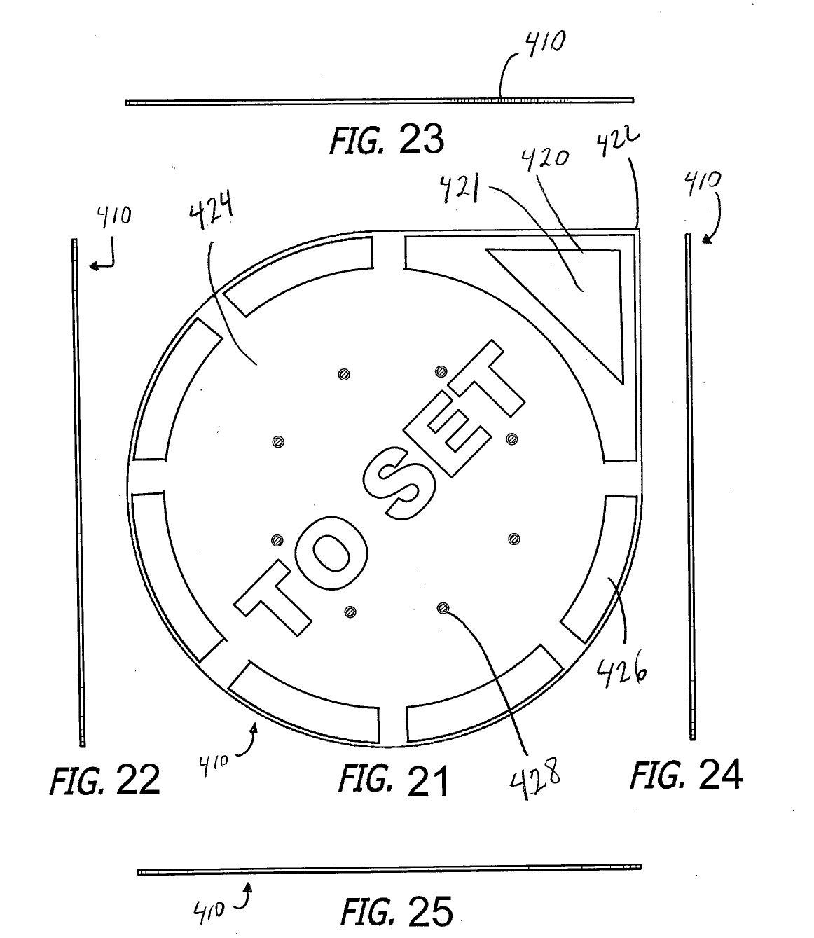

FIGS. 21 through 25 illustrate a fifth embodiment similar to that depicted in FIGS. 1 through 5, except that the triangular or cuneated shape 420 extending from the circular shape for the sign 410 further includes a smaller triangular section 421 that may be colored differently from the broken-line border 426. The smaller triangular section 421 and the border 426 may include reflective material. Preferably, as illustrated in FIG. 21, the sign has eight mounting apertures 428 corresponding to the vertexes of an octagon. Text or graphics may be placed within the interior area 424 and the peripheral area 426 may be shaded or colored to form a border. The cuneated shape 420 may have different shading or coloring from the shading or coloring of the border formed by area 426. Alternatively, the cuneated shape 420 may have the same shading or coloring as the shading or coloring of the border formed by area. The interior of area 424 preferably does not have the same color or shading as the peripheral area 426 or border.

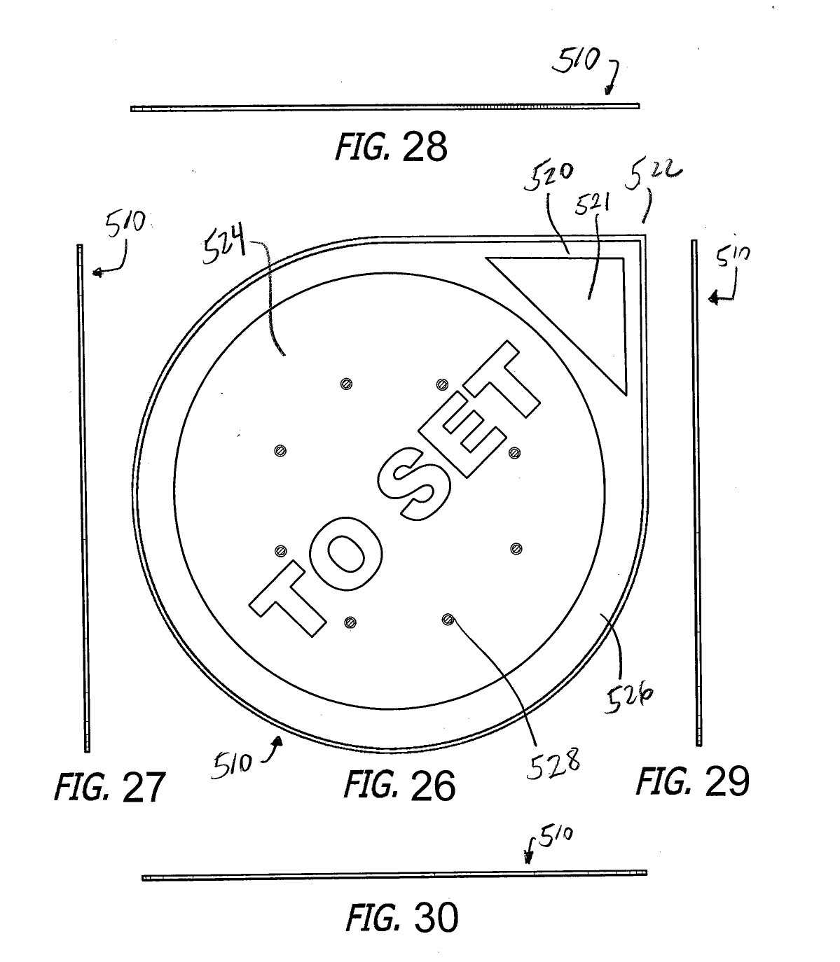

FIGS. 26 through 30 illustrate a sixth embodiment similar to that depicted in FIGS. 21 through 25, except that the border area 526 at the periphery is contiguous. The triangular or cuneated shape 520 extending from the circular shape for the sign 510 further includes a smaller triangular section 521 that may be colored differently from the border 426. This can enhance the directional or pointing aspect of the sign. The smaller triangular section 521 and the border 526 may include reflective material. Preferably, as illustrated in FIG. 26, the sign has eight mounting apertures 428 corresponding to the vertexes of an equilateral octagon. Text or graphics may be placed within the interior area 224. The interior of area 424 preferably does not have the same color or shading as the peripheral area 426 or border.

Although embodiments of the invention are described, it is understood that those skilled in the art may conceive modifications and/or variations to the specific embodiments shown and described herein. Any such modifications or variations that fall within the purview of this description are intended to be included therein as well. Unless specifically noted, the words and phrases in the specification and claims are intended to be given the ordinary and accustomed meanings to those of ordinary skill in the applicable art(s). It is, therefore, evident that the particular embodiments disclosed above may be altered or modified and all such variations are considered within the scope and spirit of the invention.

What is claimed:

1. A signage apparatus comprising:
a substrate having a shape along a plane consisting of symmetrical shape and a second shape extending from the first symmetrical shape wherein the second shape has a corner forming a directional-indicating portion.

2. The apparatus of claim 1, further comprising a octagonal head removably attachable to the substrate wherein the substrate may be repositioned on the octagonal head so that the directional-indicating portion point is orientated in another direction.

3. The apparatus of claim 1, wherein the substrate includes a plurality of mounting apertures on the symmetrical shape, wherein a pointed orientation of the directional-indicating portion of the directional sign may be changed depending on which one of the mounting apertures is used to mount the directional sign.

4. The apparatus of claim 1, wherein the substrate includes eight mounting apertures on the symmetrical shape, wherein each of the eight mounting apertures is located at a vertex for an octagon.

5. The apparatus of claim 1, wherein the substrate includes eight mounting apertures on the symmetrical shape, and each of the eight mounting apertures is located at a vertex for an equilateral octagon.

6. A directional sign comprising:
a first shape having a length and a width, wherein the first shape is symmetrical along a plane defined by the length and the width;
a second shape extending from the first shape wherein the second shape has a corner forming a directional-indicating portion of the directional sign, and an outer boundary of the directional sign is defined by the first shape and the second shape forming a single shape.

7. The directional sign of claim 6, further comprising an octagonal head sized to mate with an octagonal mounting aperture in the first shape, wherein the first shape may be repositioned on the octagonal head so that the directional-indicating portion point is orientated in a different direction.

8. The directional sign of claim 6, wherein the first shape includes a plurality of mounting apertures peripherally located on the symmetrical shape, wherein the orientation of the directional-indicating portion of the directional sign may be changed depending on which one of the mounting apertures is used to mount the directional sign.

9. The directional sign of claim 6, wherein the first shape includes eight mounting apertures on the symmetrical shape, wherein each of the eight mounting apertures is located at a vertex for an octagon.

10. The directional sign of claim 6, wherein the first shape includes eight mounting apertures on the symmetrical shape, and each of the eight mounting apertures is located at a vertex for an equilateral octagon.

11. A directional sign comprising:
a substrate having a shape along a plane consisting of symmetrical shape and a second shape extending from the first symmetrical shape wherein the second shape has a corner forming a directional-indicating portion, wherein the substrate includes eight mounting apertures peripherally located on the symmetrical shape, and each of the eight mounting apertures is located at a vertex for an octagon.

12. The directional sign of claim 11, wherein the first shape includes a peripheral border along a perimeter defined by the symmetrical shape, the peripheral border having a different color from the symmetrical shape adjacent to the peripheral border, and the eight mounting apertures are located within an area defined by the peripheral border.

13. The directional sign of claim 11, wherein the first shape includes a broken-line peripheral border along a perimeter defined by the symmetrical shape, the peripheral border having a different color from the symmetrical shape adjacent to the peripheral border.

14. The directional sign of claim 11, wherein the first shape includes a broken-line peripheral border along a perimeter defined by the symmetrical shape, the peripheral border having a different color from the symmetrical shape adjacent to the peripheral border; and wherein the peripheral border extends into the second shape and the peripheral border of the second shape further includes a triangular section having a color different from the color of the peripheral border.

15. The directional sign of claim 11, wherein the first shape includes a peripheral border along a perimeter defined by the symmetrical shape, the peripheral border having a different color from the symmetrical shape adjacent to the peripheral border; and wherein the peripheral border extends into the second shape and the peripheral border of the second shape further includes a triangular section having a color different from the color of the peripheral border.

16. The directional sign of claim 11, wherein the first shape is circular, and the second shape is cuneated.
